(19) United States
(12) Patent Application Publication
(10) Pub. No.: US 2007/0185908 A1
(43) Pub. Date: Aug. 9, 2007

(54) SYSTEM AND METHOD FOR RECORDING TIMESHEET ENTRY DATA OF EMPLOYEES

(75) Inventors: CHUNG-I LEE, Tu-Cheng (TW); YUE-HAI YI, Shenzhen (CN); WEI-QING XIAO, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,848

(22) Filed: Nov. 17, 2006

(30) Foreign Application Priority Data
Jan. 24, 2006 (CN) 200610033478.X

(51) Int. Cl. G06F 7/00

(52) U.S. Cl. 707/104.1

(57) ABSTRACT

A system for recording timesheet entry data of employees is provided. The system includes at least one client computer and an application server. Each client computer includes a timesheet entry data inserting module used for receiving timesheet entry data input by an employee, attaching the timesheet entry data to the email, and sending the email with the timesheet entry attachment to a preset timesheet mailbox after the user sends out the email. The application server is used for accessing the preset timesheet mailbox periodically to obtain timesheet entry data of various employees, which are attached to different emails, and inserting the attached data to a database.

### BACKGROUND OF THE INVENTION

1. Field of the Invention

The present invention relates to a system and method for recording timesheet entry data of employees.

2. Description of Related Art

Historically, people communicated with others through the telephone or mail, with the development of computers and network technologies, now more and more communications are made through electronic mails (email).

At present, almost all enterprises adopts emailing as a communication means to communicate each other instantly and efficiently. Often, after an employee has processed a task, the employee would send out an email to a related person (e.g. a leader of the employee or a related client) to reflect resource allocation information about the task. Additionally, to some employees in an enterprise, an amount of time the employees spent on assigned tasks is used as a basis for their compensations (e.g. a lawyer).

A traditional and common method for such employees to record the timesheet entry data is that: firstly, the employee (such as the lawyer) sends out an email to a related person (such as a client) to reflect resource allocation information about a task in an email system; then the employee accesses a timesheet entry data recording system to type out “I have spent * hours about something”.

One drawback of the above manner, is that switching from one data processing system (such as the email system) to another data processing system (such as the timesheet entry data recording system) is time-consuming.

What is needed, therefore, is a system and method for recording timesheet entry data of employees in combination with emails that processed by employees, so as to improve work efficiency and avoid repeating operation.

### SUMMARY OF THE INVENTION

A system for recording timesheet entry data of employees according to a preferred embodiment is provided. The system includes at least one client computer and an application server. Each client computer includes a timesheet entry data inserting module for receiving timesheet entry data input by an employee, attaching the timesheet entry to an email created by the employee, and sending the email with the timesheet entry attachment to a preset timesheet mailbox after the employee sends out the email. The application server is used for accessing the preset timesheet mailbox periodically to obtain timesheet entry data of various employees, which are attached to different emails, and inserting the attached timesheet entry data to a database.

Another preferred embodiment provides a method for recording timesheet entry data of employees. The method includes the steps of: (a) receiving timesheet entry data input by an employee; (b) attaching the timesheet entry to an email created by the employee; (c) sending the email with the timesheet entry attachment to a preset timesheet mailbox, after the employee sends out the email; (d) checking the preset timesheet mailbox periodically to obtain timesheet entry data of various employees which are attached to different new emails; and (e) inserting the attached timesheet entry data to a database.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 is a schematic diagram illustrating a system for recording timesheet entry data of employees according to a preferred embodiment;

FIG. 2 is a flowchart of a preferred method for recording timesheet entry data of employees; and

FIG. 3 is a detail description of one step in FIG. 2, namely periodically checking the preset timesheet mailbox to obtain the attached timesheet entry data.

### DETAILED DESCRIPTION OF THE PREFERRED EMBODIMENT

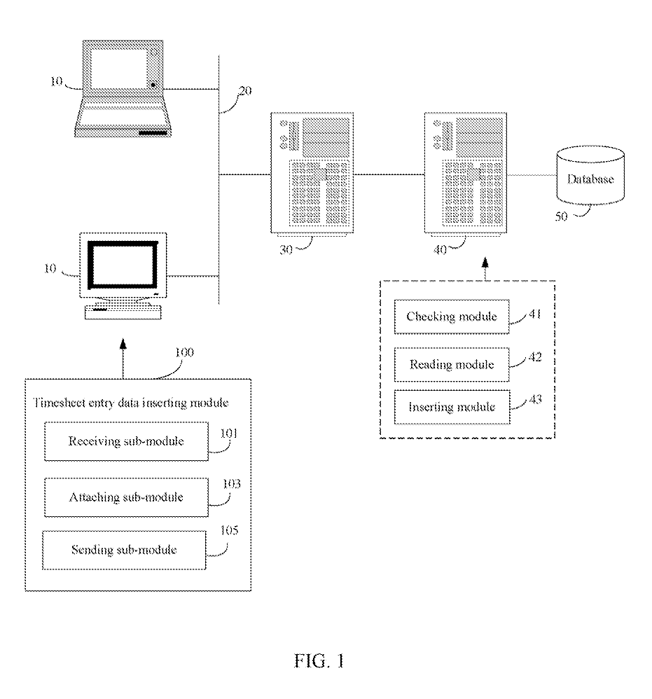

FIG. 1 is a schematic diagram illustrating a system for recording timesheet entry data according to a preferred embodiment. The system includes a plurality of distributed client computers 10 (only two shown), a network 20, an email server 30, and an application server 40. Each client computer 10 is connected to the email server 30 and the application server 40 through the network 20. In this embodiment, the email server 30 is a LOTUS NOTES server (hereinafter, “the NOTES server 30”). In other embodiments, the email server 30 may be any other kind of email server.

Each client computer 10 provides an email client software for users, such as employees of an enterprise, contractors, designated task assignees, to login to email accounts and to receive/send emails. Accordingly, in this embodiment, LOTUS NOTES client software is adopted as the email client software. Additionally, each client computer 10 includes a timesheet entry data inserting module 100, installed/integrated in the LOTUS NOTES email client software as an object linking and embedding control Extension (OLE/OCX). The timesheet entry data inserting module 100 is configured for providing a user interface to insert a timesheet entry with data, attaching the timesheet entry to an email, and sending the email with the timesheet entry attachment to a preset timesheet mailbox in the NOTES server 30.

The NOTES server 30 is used for assigning a LOTUS NOTES email account for each employee, receiving emails from or sending emails to the email accounts.

The application server 40 is used for monitoring the preset timesheet mailbox periodically to obtain/read/extract timesheet entry data attached to emails, and inserting the attached timesheet entry data to a database 50 connected to the application server 40.

The timesheet entry data inserting module 100 includes: a receiving sub-module 101, an attaching sub-module 103, and a sending sub-module 105. The receiving sub-module 101 is used for receiving timesheet entry data inputted by an employee. The attaching sub-module 103 is used for attaching the timesheet entry to an email. The sending sub-module 105 is used for sending the email with the timesheet entry attachment to the preset timesheet mailbox in the NOTES server.

The application server 40 includes: a checking module 41, a reading module 42, and an inserting module 43. The checking module 41 is used for periodically scanning whether there are new/unread/unopened emails in the preset timesheet mailbox. The reading module 42 is used for reading data of the timesheet entry attached to the new emails in the preset timesheet mailbox. The inserting module 43 is used for inserting the timesheet entry data to the database 50.

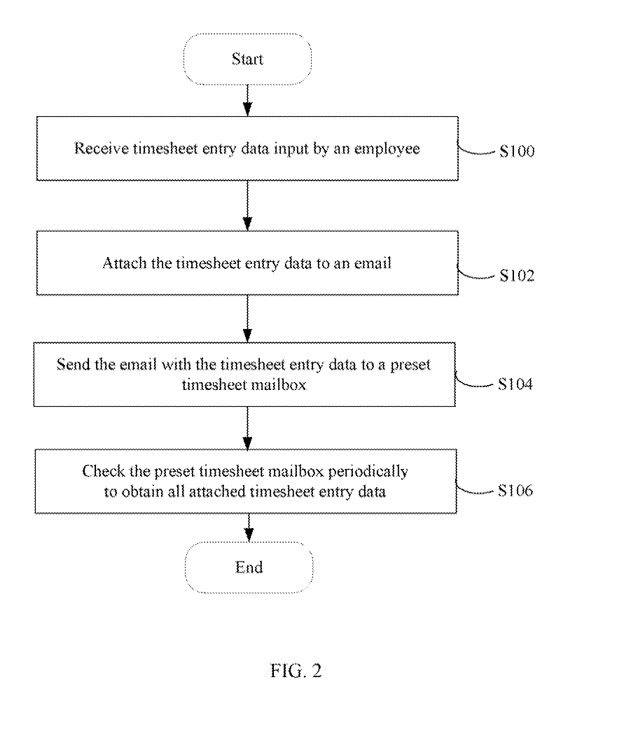

FIG. 2 is a flowchart of a preferred method for recording timesheet entry data of employees. Firstly, an employee (e.g. a lawyer) at a client computer 10 opens a timesheet entry attachable email via the email client software, such as LOTUS NOTES client software to reflect resource allocated towards a task to a designated person (e.g. a leader of the employee, project manager, human resource, and/or a client). In step S100, the receiving sub-module 101 receives timesheet entry data inputted by the employee. Such data may include a task number, and time/resource information on the task. In step S102, the attaching sub-module 103 attaches the timesheet entry to the email. In step S104, the sending sub-module 105 sends the email with the timesheet entry attachment to a preset timesheet mailbox after the employee sends out the email. In step S106, the application server 40 checks the preset timesheet mailbox periodically, for example, once a week, to obtain the attached data of each new email in the preset timesheet mailbox.

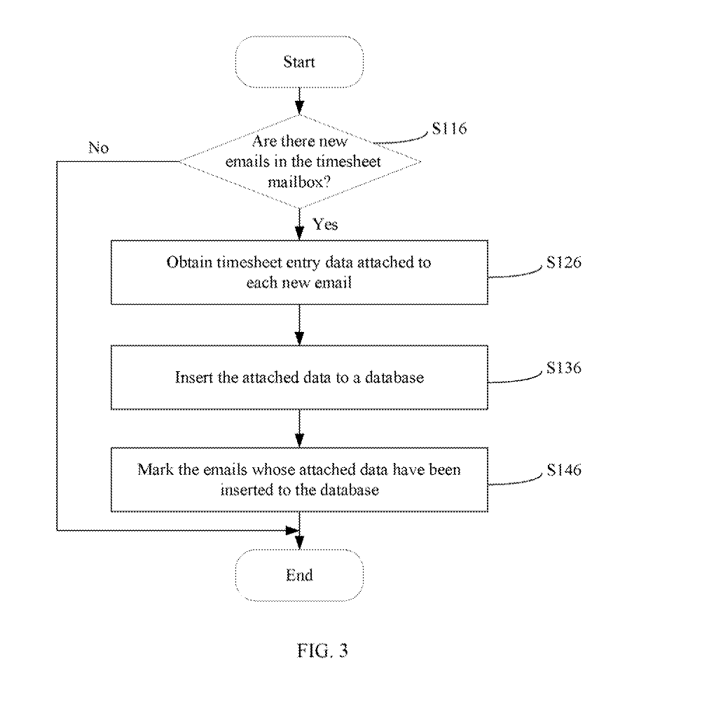

FIG. 3 is a detailed description of step S106, namely the checking step that the application server 40 executes on the preset timesheet mailbox. In step S116, the checking module 41 checks whether the preset timesheet mailbox has received new emails. If the preset timesheet mailbox receives new emails, in step S126, the reading module 42 reads data from the timesheet entry attached to each new email. In step S136, the inserting module 43 inserts the data to the database 50. In step S146, the checking module 41 marks the emails whose attached data have been inserted to the database 50.

If, in step S116, the checking module 41 detects that the preset timesheet mailbox has not received any new email, the procedure ends. In a next checking period, the application server 40 repeats from step S116 to step S146.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for recording timesheet entry data of employees, comprising: at least one client computer which comprises a timesheet entry data inserting module for receiving timesheet entry data input by an employee, attaching the data to an email created by the employee, and sending the email with the timesheet entry attachment to a preset timesheet mailbox after the employee sends out the email; and
an application server for accessing the preset timesheet mailbox periodically to obtain timesheet entry data of various employees which are attached to different emails, and inserting the attached timesheet entry data to a database.

2. The system as claimed in claim 1, wherein the application server comprises:
a checking module for periodically checking whether the preset timesheet mailbox has received a new email;
a reading module for reading the timesheet entry data attached to the new email; and
an inserting module for inserting the attached timesheet entry data to the database.

3. The system as claimed 2, wherein the checking module is further used for marking the new email whose attached timesheet entry data have been inserted to the database.

4. A computer-based method for recording timesheet entry data of employees, comprising the steps of
receiving timesheet entry data input by an employee;
attaching the timesheet entry data to an email created by the employee;
sending the email with the timesheet entry attachment to a preset timesheet mailbox, after the employee sends out the email;
checking the preset timesheet mailbox periodically to obtain timesheet entry data of various employees which are attached to different new emails; and
inserting the attached timesheet entry data to a database.

5. The method as claimed in claim 4, further comprising the step of
marking the new emails whose attached timesheet entry data have been inserted to the database.
